(19) United States
(12) Patent Application Publication
(10) Pub. No.: US 2013/0014394 A1
(43) Pub. Date: Jan. 17, 2013

(54) CUTTER FOR WOVEN BELTS

(71) Applicant: Hsiu-Man YU CHEN, Taichung City (TW)

(72) Inventor: Hsiu-Man YU CHEN, Taichung City (TW)

(21) Appl. No.: 13/181,642

(22) Filed: Jul. 13, 2011

(51) Int. Cl. B26B 25/00; B26B 29/00

(52) U.S. Cl. 30/276; 30/280; 30/291

(57) ABSTRACT

A cutter for woven belts includes a handle having two ends respectively defined to be a first end and a second end. The handle has a circumferential side provided with a cutting opening located close to the first end, extended in a direction from the second end toward the first end and having an opposite sealed end connected with two guide grooves. A blade deposited in the handle is exposed in the cutting opening. Thus, when a woven belt is being cut by the cutter, the cut-off portion of the woven belt will be guided by the guide grooves to be separated from the original woven belt so that the woven belt cut apart can be prevented from being accumulated at the cutting opening or being hindered by a user's hand, enabling the cutter to effectively cut off woven belts for facilitating sequent work of removing the woven belts from goods.

### BACKGROUND OF THE INVENTION

1. Field of the Invention

This invention relates to a cutter for woven belts.

2. Description of the Prior Art

Woven belts are frequently used for binding and fixing goods to prevent the goods from rocking or colliding and being scattered on the way of transportation, and for facilitating sequent work of removing the woven belts from the goods, a cutter specially used for cutting off woven belts is devised. A conventional cutter 100 for woven belts, as shown in FIG. 1, is formed with a handle 401 having two ends respectively defined to be a first end 402 and a second end 403, and a circumferential side provided with a cutting opening 404 defined by the first end 402 and another end 405 and extending toward the second end 403 and an opposite sealed end 406. The handle 401 of the cutter 400 is set in the interior with a blade 407 having a blade edge 408 exposed in the cutting opening 404. In using, as shown in FIG. 2, simply grasp the handle 401 to have the cutting opening 404 aligned to a woven belt 200 and then push the cutter 400 toward the woven belt 200 to let the blade 407 cut off the woven belt 200.

However, since the woven belt 200 is made of soft cloth by weaving, and the cutting opening 404 of the cutter 400 is provided in a direction from the first end 402 toward the second end 403; therefore, in the course of cutting off the woven belt 200, if the width of the woven belt 200 is larger than the length of the cutting opening 404, the woven belt 200, with some part cut apart and some part uncut, so the part cut is easy to be accumulated to the sealed end 406 of the cutting opening 404 or to be hindered by a user's hand. As a result, the conventional cutter 400 fails to effectively cut completely off the woven belt 200.

### SUMMARY OF THE INVENTION

The objective of this invention is to offer a cutter for woven belts, able to effectively cut off woven belts for facilitating sequent work of removing woven belts from goods.

The cutter for woven belts in the present invention includes a handle and a blade as main components combined together. The handle has two ends respectively defined to be a first end a second end and has a circumferential side provided with a cutting opening that is located close to the first end, extended in a direction from the second end toward the first end and formed with an open end and an opposite sealed end. Further, the handle has two sides respectively disposed with a guide groove at a location adjacent to the first end, and each guide groove has one end connected with the sealed end of the cutting opening and another end formed with a guide slope slanting outward lengthwise along the cutting opening. The blade is assembled with the handle, abutting against the cutting opening and having its circumferential side provided with a blade edge that is exposed in the cutting opening.

Since the cutting opening of the cutter of this invention is provided in a direction from the second end toward the first end; therefore, in a cutting process, a user's hand is moved in a direction distant from the woven belt, able to prevent the woven belt that is cut apart from hindered by the user's hand. In addition, after cut apart, the cut portion of the woven belt can be guided by the guide slopes of the guide grooves to be separated from the original woven belt, able to prevent the woven belt cut apart from being accumulated at the sealed end of the cutting opening. By so designing, the cutter of this invention can effectively cut off woven belts for facilitating sequent work of removing woven belts from goods.

### BRIEF DESCRIPTION OF DRAWINGS

This invention will be better understood by referring to the accompanying drawings, wherein:

FIG. 1 is a perspective view of a conventional cutter for woven belts;

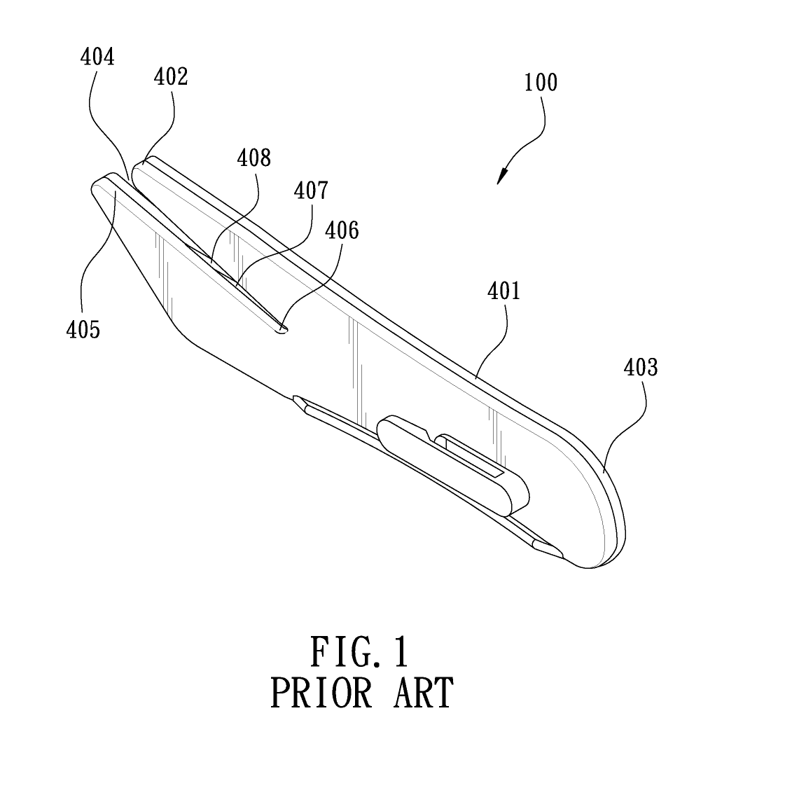

FIG. 2 is a schematic view of the conventional cutter for woven belts in a using condition;

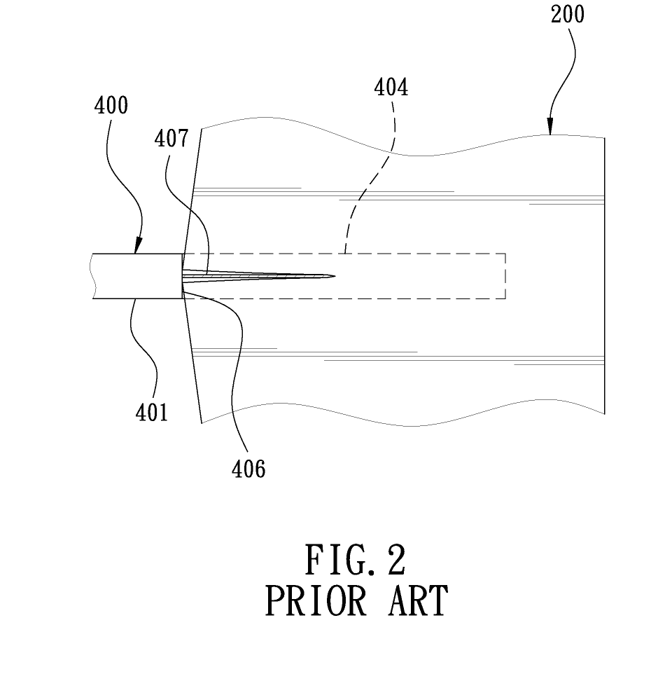

FIG. 3 is a perspective view of a cutter for woven belts in the present invention;

FIG. 4 is an exploded perspective view of the cutter for woven belts in the present invention;

FIG. 5 is a side view of the cutter for woven belts in the present invention;

FIG. 6 is a cross-sectional view of the line A-A in FIG. 5;

FIG. 7 is a schematic view of the cutter for woven belts in the present invention, illustrating that the blade of the cutter is cutting off a woven belt;

FIG. 8 is a schematic view of the cutter for woven belts in the present invention, illustrating that the woven belt already cut apart is guided to separate by the guide grooves;

FIG. 9 is a schematic view of the cutter in the present invention, illustrating that a packing carton is unsealed by the pointed member of the cutter; and

FIG. 10 is a schematic view of the cutter in the present invention, illustrating that the blade of the cutter is rotated for an angle.

### DETAILED DESCRIPTION OF THE PREFERRED EMBODIMENT

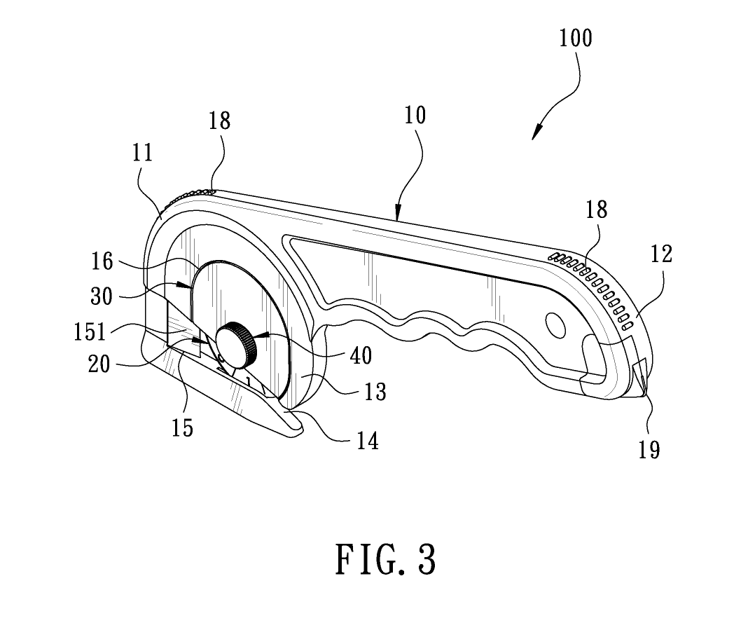

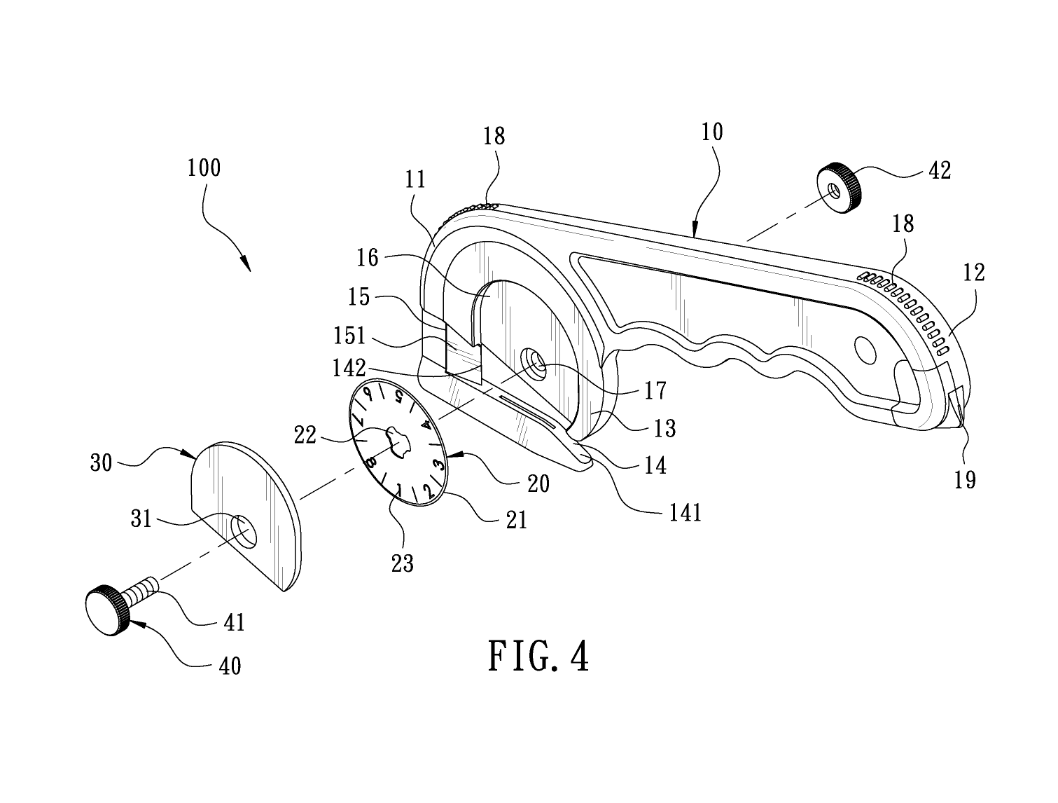

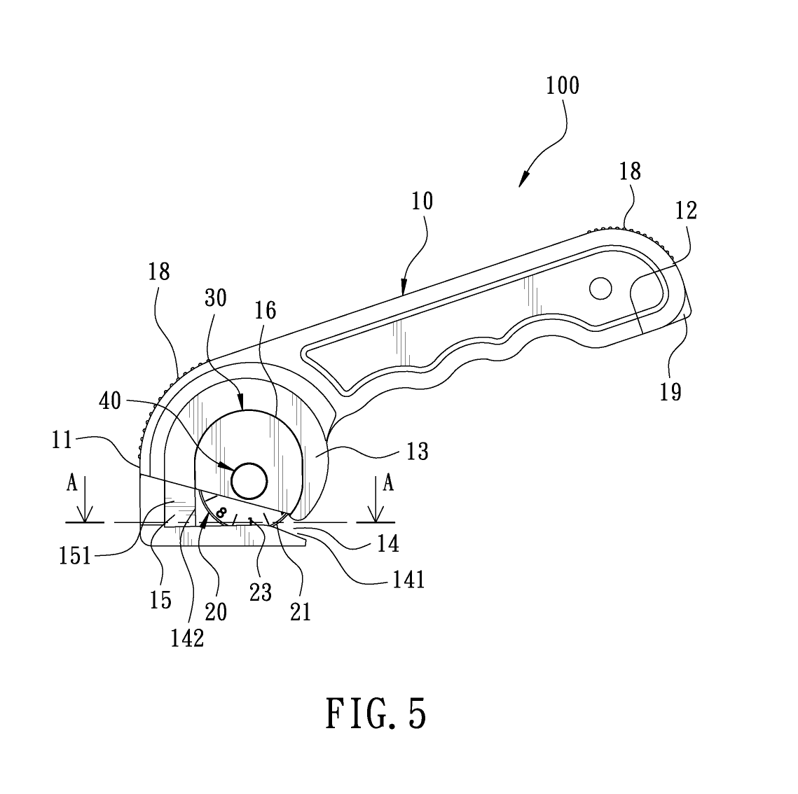

A preferred embodiment of a cutter for woven belts in the present invention, as shown in FIGS. 3, 4 and 5, includes a handle 10, a blade 20, a fixing plate cover 30 and a fixing member 40 as main components combined together.

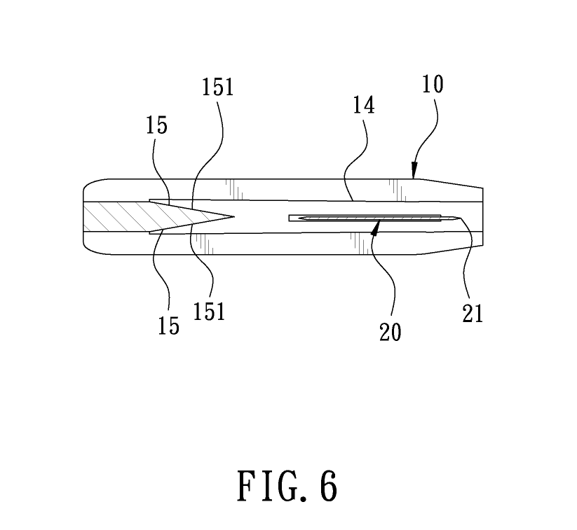

The handle 10 has two ends respectively defined to be a first end 11 and a second end 12, and a cutting portion 13 is extended transversely from the first end 11. The handle 10 further has a circumferential side bored with a cutting opening 14 at a location adjacent to the first end 11. In this preferred embodiment, the cutting opening 14 is disposed in the cutting portion 13, extended in a direction from the second end 12 toward the first end 11 and formed with an open end 141 and an opposite sealed end 142. Furthermore, the handle 10 has two sides respectively cut with a guide groove 15 located close to the first end 11. In this preferred embodiment, the two guide grooves 15 are respectively positioned at the two sides of the cutting portion 13, respectively having one end connected with the sealed end 142 of the cutting opening 14 and another end formed with a guide slope 151 extending and slanting outward lengthwise along the cutting opening 14, as shown in FIG. 6, and connected with the circumferential side of the cutting portion 13. In addition, the cutting portion 13 is provided with an accommodating groove 16 communicating with the cutting opening 14 and bored with a first insert hole 17 near the bottom, and has a circumferential side close to the first end 11 provided thereon with a plurality of anti-skid bumps 18 and another circumferential side close to the second end 12 set thereon with a plurality of anti-skid projection 18 and a protruding pointed member 19.

The blade 20 is assembled with the handle 10 at a location abutting against the cutting opening 14 and has its circumferential side provided with a blade edge 21 exposed in the cutting opening 14. In this preferred embodiment, the blade 20 is received in the accommodating groove 16 of the cutting portion 13, bored with a second insert hole 22 corresponding with the first insert hole 17 and having one side provided with a plurality of marks 23, which can be bulging points or carved lines shown in this preferred embodiment.

The fixing plate cover 30 is to be fixed in the accommodating groove 16 and positioned at the outer side of the blade 20 for restrictedly positioning the blade 20 in the accommodating groove 16. The fixing plate cover 30 is bored with a third insert hole 31 to correspond with the first insert hole 17 of the accommodating groove 16.

The fixing member 40 includes a bolt 41 to be inserted through the first insert hole 17, the second insert hole 22 and the third insert hole 31, and a nut to be secured at the end of the bolt 41 for combining the fixing plate cover 30 together with the blade 20 and handle 10.

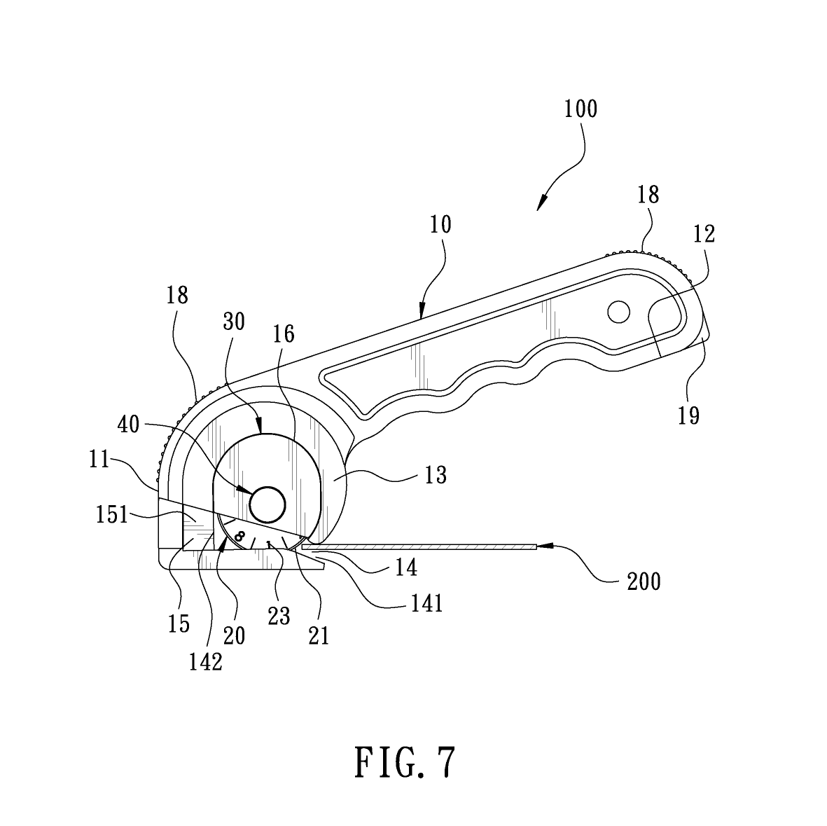

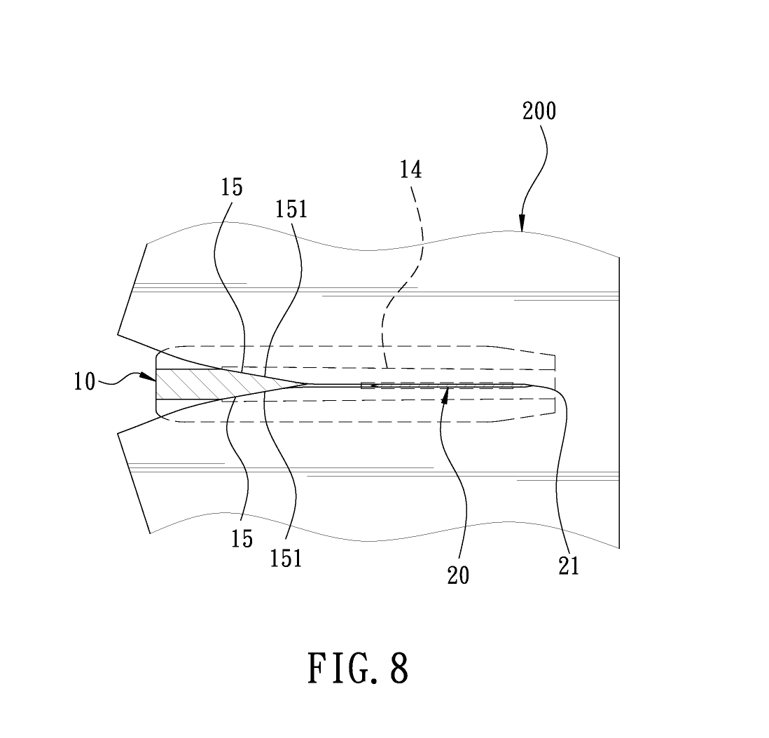

To use the cutter 100 to cut off a woven belt 200, referring to FIGS. 7 and 8, only hold the handle 10 to let the opening end 141 of the cutting opening 14 aligned to the woven belt 200 and then, push the cutter 100 to move toward the woven belt 200 to let the blade edge 21 of the blade 20 cut off the woven belt 200. Since the cutting opening 14 is provided in a direction from the second end 12 toward the first end 11; therefore, in a cutting process, a user's hand is moved at a place distant from the woven belt 200, able to prevent the woven belt 200 that has been cut apart from being hindered by the user's hand. Additionally, the cutting portion 13 has two sides respectively disposed with the guide groove 15 so, after cut apart, the cut portion of the woven belt 200 will be guided by the guide slopes 151 of the guide grooves 15 to be separated from the original woven belt, able to prevent the woven belts 200 cut apart from being accumulated at the sealed end 142 of the cutting opening 14. By so designing, the cutter 100 of this invention can effectively cut off the woven belt 200 and, even if the width of the woven belt 200 is larger than the length of the cutting opening 14 of the cutter 100, the woven belt 200 having been cut apart will not be accumulated at the cutting opening 14; nor will it be hindered by a user's hand, facilitating sequent work of removing the woven belts 20 from goods.

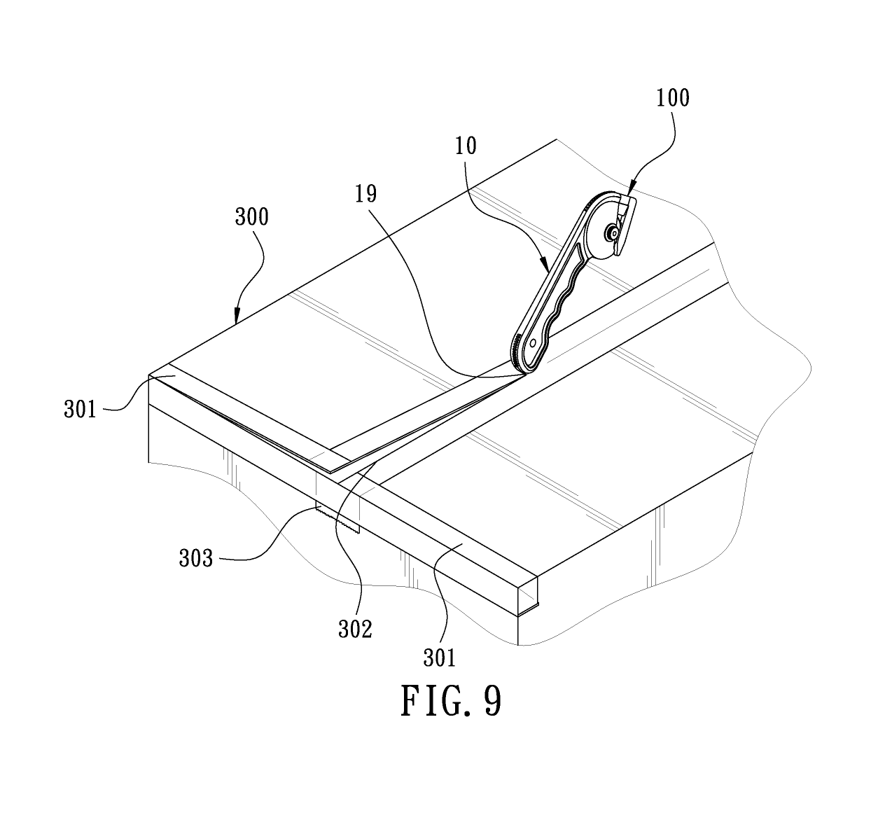

Referring to FIG. 9, aside from using woven belts 200 for fixing goods, cartons 300 are often used for packing of articles, and the cutter 100 of this invention can also be used for unpacking cartons 300 with easiness. To unseal a carton 300, simply hold the cutter 100 reversely to have the pointed member 19 of the handle 10 aligned to and pierced through the joint portion 302 of two side plates 301 of the carton 300 to cut open the adhesive tape 303 for unsealing the carton 300, thus able to enlarge the application range of the cutter 100.

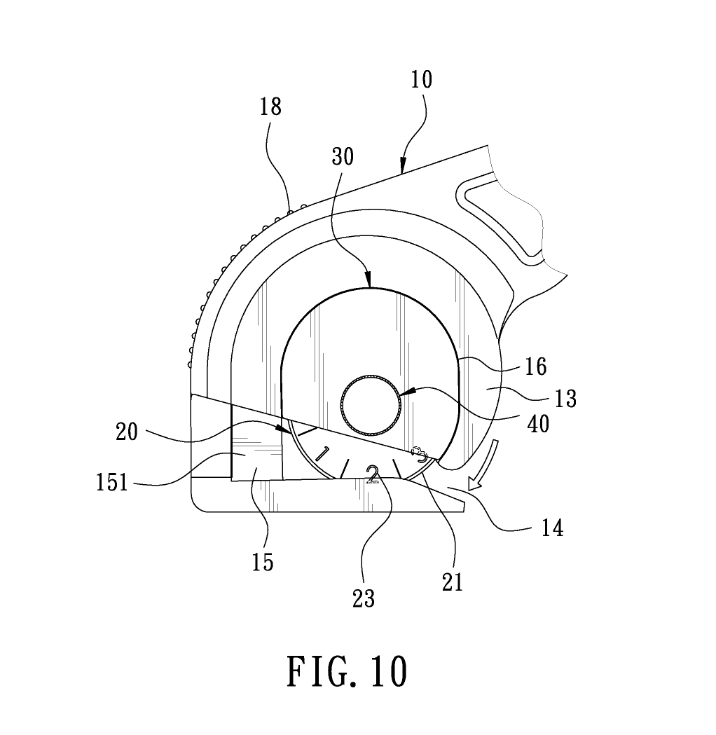

Referring to FIG. 10, the circumferential side of the blade 20 is formed with the blade edge 21 and the blade 20 is provided thereon with marks 23. Therefore, when the blade 20 is used for a long period and the blade edge 21 becomes dull or produces wearing and chamfering, simply unscrew the fixing member 40 and turn the blade 20 for an angle according to indication of the marks 23 and thus, other parts of the blade edge 21, which are not yet damaged, can continuously be used for cutting off the woven belt 200, needless to replace the blade 20 frequently and able to save cost.

Another special feature of this invention is that the handle 10 has its circumferential side provided with plural anti-skid bumps 18 at locations respectively close to the first end 11 and the second end 12 so as to achieve an excellent effect of slip prevention and enable a user to operate the cutter 100 with convenience whether he holds the handle 10 directly or reversely.

While the preferred embodiment of the invention has been described above, it will be recognized and understood that various modifications may be made therein and the appended claims are intended to cover all such modifications that may fall within the spirit and scope of the invention.

What is claimed is:

1. A cutter for woven belts comprising:
a handle having two ends respectively defined to be a first end and a second end, said handle having a circumferential side bored with a cutting opening, said cutting opening provided in a direction from said second end toward said first end, said cutting opening formed with an open end and an opposite sealed end, said handle having two sides respectively provided with a guide groove at a location adjacent to said first end, said guide groove having one end connected with said sealed end of said cutting opening, said guide groove having another end slanting and extending outward lengthwise along said cutting opening and forming a guide slope; and
a blade assembled with said handle and positioned close to said cutting opening, said blade having circumferential side provided with a blade edge, said blade edge exposed in said cutting opening.

2. A cutter for woven belts as claimed in claim 1, wherein said handle is formed with a cutting portion extended transversely at a location close to said first end, said cutting portion provided with said cutting opening and said guide grooves, said blade mounted with said cutting portion.

3. A cutter for woven belts as claimed in claim 2, wherein said cutting portion is disposed with an accommodating groove communicating with said cutting opening, said blade received in said accommodating groove, said cutter further provided with a fixing plate cover, said fixing plate cover secured with said accommodating groove and positioned at an outer side of said blade.

4. A cutter for woven belts as claimed in claim 3, wherein said accommodating groove is bored with a first insert hole and said blade is provided with a second insert hole corresponding to said first insert hole while said fixing plate cover is formed with a third insert hole corresponding to said second insert hole, said cutter further provided with a fixing member, said fixing member inserted and fixed in said first insert hole, said second insert hole and said third insert hole.

5. A cutter for woven belts as claimed in claim 4, wherein said fixing member is composed of a bolt and a nut, said bolt inserted through said first insert hole and said second insert hole and said third insert hole, said nut firmly screwed with one end of said bolt.

6. A cutter for woven belts as claimed in claim 1, wherein said handle has a circumferential side formed thereon with a plurality of anti-skid bumps at locations respectively adjacent to said first end and said second end.

7. A cutter for woven belts as claimed in claim 1, wherein said handle has a circumferential side set with a protruding pointed member positioned close to said second end.

8. A cutter for woven belts as claimed in claim 1, wherein said blade has one side annularly disposed with a plurality of marks arranged along a circumferential edge.

9. A cutter for woven belts as claimed in claim 8, wherein said marks are carved lines.
